(19) United States
(12) Patent Application Publication
(10) Pub. No.: US 2016/0292793 A1
(43) Pub. Date: Oct. 6, 2016

(54) SELECTION AND DISPLAY OF A FEATURED PROFESSIONAL PROFILE CHOSEN FROM A SOCIAL NETWORKING SERVICE

(71) Applicant: Linkedln Corporation, Mountain View, CA (US)

(72) Inventors: Elizabeth Ethel Burstein, San Francisco, CA (US); Kechun Mao, Pittsburgh, PA (US)

(21) Appl. No.: 14/697,341

(22) Filed: Apr. 27, 2015

Related U.S. Application Data
(60) Provisional application No. 62/141,227, filed on Mar. 31, 2015.

(51) Int. Cl. G06Q 50/00; G06F 17/30

(52) U.S. Cl. CPC G06Q 50/01; G06F 17/30905

(57) ABSTRACT

In various example embodiments, a social network server maintains a social networking service having a plurality of member profiles, each member profile being associated with a member of the social networking service. When the social networking service is accessed by a member, the member is presented with a user interface for interacting with the social networking service where the user interface presents information associated with the member's profile. In addition, the social network server includes various modules for presenting a featured professional profile at a predetermined location within the user interface. These modules include a featured profile selection module, a feature profile display module, and a featured profile communication module that interact to select and display the featured professional profile selected from the various member profiles associated with the social networking service.

### CROSS-REFERENCE TO RELATED APPLICATIONS

This patent application claims the benefit of priority to U.S. Pat. App. No. 62/141,227, filed Mar. 31, 2015 and titled “SELECTION AND DISPLAY OF A FEATURED PROFESSIONAL PROFILE CHOSEN FROM A SOCIAL NETWORKING SERVICE,” the disclosure of which is hereby incorporated by reference in its entirety.

### TECHNICAL FIELD

Embodiments of the present disclosure relate generally to data processing and analysis and, more particularly, but not by way of limitation, to selecting and displaying a featured professional chosen from member profiles associated with a social networking service.

### BACKGROUND

A social networking service is a service that connects members of a community. The social networking service typically maintains member profiles, each profile being associated with a corresponding member. The member profile includes attributes that define the corresponding member. These attributes include such characteristics as the member's name, the member's place of employment, the member's title and/or job function, and/or connections to other members of the social networking service.

A member of the social networking service may leverage the service to promote himself or herself. For example, a member may list various articles or publications that he or she has published to demonstrate experience or expertise in a given field or industry. The member may promote himself or herself in the expectation that another member may engage or hire the promoting member for a particular endeavor. Similarly, an inquiring member may desire to find a member having a given level of experience or expertise in a given industry or field. However, as the social networking service includes hundreds of thousands of member profiles, it can be difficult for the promoting member to be noticed by other members of the social networking service or for the inquiring member to find a member having the requisite experience or expertise.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a social network server in communication with various client devices and external information sources in accordance with an example embodiment.

FIG. 2 is a block diagram illustrating the components of the social network server of FIG. 1 in accordance with an example embodiment.

FIG. 3 is a block diagram illustrating the panels of a user interface, according to an example embodiment, for interacting with the social network server.

FIG. 4 illustrates a user interface, according to an example embodiment, for nominating members to be a featured professional of a social networking service.

FIG. 5 illustrates a user interface, according to an example embodiment, for interacting with the social network server.

FIG. 6 illustrates logic flow for selecting a member profile to be a featured professional profile according to an example embodiment.

FIG. 7 illustrates additional logic flow for selecting the member profile to be a featured professional profile according to an example embodiment.

FIG. 8 illustrates logic flow for receiving nominations for a member profile to be a featured professional profile according to an example embodiment.

FIG. 9 illustrates logic flow, according to an example embodiment, for obtaining external information to be used in determining whether a member profile should be selected as a featured professional profile.

FIG. 10 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, this disclosure provides for a social network server that includes various modules for facilitating the promotion and display of a member profile as a featured professional profile. The social network server may determine whether a member profile is associated with various events, and then determine whether the events distinguish the member profile from other member profiles. Events may include article publications, news mentions, issued patents or issued patent application publications where the member is listed as an inventor, and other such events. Each event may be assigned one or more values and/or weights, and the values and/or weights may be computed (e.g., by addition, multiplication, etc.) to yield an achievement value for the corresponding member profile.

The social network server can also use other attributes in determining whether a member profile should be considered a featured professional profile. For example, the social network server may use the number of views a member profile has received during a given time period. In one embodiment, the time period is a 4-week period such that a predetermined threshold of member profiles having the greatest number of profile views during the 4-week period are considered to be potential featured professional profiles. The predetermined threshold may be a percentage (e.g., the top 10% of member profiles having the highest number of profile views) and/or an absolute view (e.g., the top 200 member profiles having the highest number of profile views).

Furthermore, whether the member profile is merely viewed (e.g., within a content stream) or engaged (e.g., another member provides feedback on content published by the member) is also considered in the determination of whether the member profile should be considered a featured professional profile. In one embodiment, where the member profile is displayed within the content stream distributed to other members, each display increases the achievement value assignable to the member profile by a first predetermined amount (e.g., a value of 1, a value of 0.5, etc.). In contrast, where another member engages the content published by the member under consideration (e.g., shares the content with other members, indicates an agreement with the published content, etc.), the achievement value assignable to the member profile is increased by a second, higher predetermined amount (e.g., a value of 2, a value of 1, etc.). In this manner, member profiles that increase the engagement by other members of the social network service are more likely to be designated as featured professional profiles than member profiles that are merely displayed, but not engaged, by other members of the social network service.

In addition, the social network server is configured to pull in information from external sources, such as journal article databases, patent databases, news websites, product websites, and other such sources of information. The external information gathered from these sources is useful in determining whether a member profile should be a featured professional profile because, if the member associated with the member profile is mentioned in the information gathered from an external source, then there is an increased likelihood that the member is more visible to members of the general public or has a higher name recognition.

Of course, some mentions of a member may be negative, and the social network server is configured to notify a moderator to review the external information should the external information contain context information indicating a likelihood that the external information is negative. One example of context information is a predetermined set of words and/or phrases (e.g., “accident,” “alleged,” “jail,” “sentencing,” etc.) that, when a threshold number of these words and/or phrases are encountered, the social network server notifies a moderator to review the external information to confirm whether the external information should be used in evaluating whether the member profile should be considered as a featured professional profile.

Accordingly, in one embodiment, this disclosure provides for a system that includes a machine-readable memory having computer-executable instructions stored thereon, and at least one processor that, having executed the computer-executable instructions, is configured to analyze a first plurality of user profiles maintained by a social networking service to determine whether a user associated with a user profile selected from the first plurality of user profiles has accomplished one or more predetermined events selected from a plurality of predetermined events, assign an achievement value to each of the first plurality of user profiles, an achievement value corresponding to a user profile being determined based on the determination of whether the user associated with the user profile has accomplished the one or more predetermined events, rank a second plurality of user profiles selected from the first plurality of user profiles, the ranking being performed according to the achievement value assigned to a corresponding user profile, and select at least one user profile from the second plurality of ranked user profiles to be a featured professional profile, the selection based on a threshold value defining a number of user profiles that are to be considered featured professional profiles.

The at least one processor is also configured to access the social networking service to obtain profile information associated with the at least one featured professional profile and cause the display of the obtained profile information in a predetermined portion of a display in communication with a user device.

In another embodiment of the system, the at least one processor is further configured to obtain a geographic location associated with each of the user profiles selected from the first plurality of user profiles, determine a geographic region associated with the obtained geographic locations, and select the second plurality of user profiles from the first plurality of profiles according to the determined geographic region. In addition, the at least one processor is further configured to cause the display of the obtained profile information based on the determined geographic region.

In a further embodiment of the system, the at least one processor is further configured to obtain an industry associated with each of the user profiles selected from the second plurality of user profiles, select a third plurality of user profiles from the second plurality of user profiles based on the industry associated with a corresponding user profile, and rank the third plurality of user profiles selected from the second plurality of user profiles, the ranking being performed according to the achievement value assigned to a corresponding user profile.

In yet another embodiment of the system, the at least one processor is configured to cause the display of a third plurality of user profiles on the user device, the third plurality of user profiles being selected from the first plurality of user profiles based on the third plurality of user profiles being connected to a member profile that the third plurality of user profiles have in common, and receive a nomination for at least one user profile selected from the third plurality of user profiles from a user represented by the common member profile, the nomination indicating a preference for the at least one user profile to be a featured professional profile.

In yet a further embodiment of the system, the second plurality of user profiles includes the third plurality of user profiles, and the at least one processor is further configured to rank the second plurality of user profiles according to the received nomination.

In another embodiment of the system, the at least one processor is configured to send a message to a user associated with the selected at least one user profile to be featured as the featured professional profile, the message indicating the selection of the at least one user profile to be featured as the featured professional profile, and receive a reply from the user, the reply indicating a willingness by the user to have the at least one user profile be featured as the featured professional profile. In addition, the at least one processor is further configured to assign a responsiveness value to the at least one user profile based on the timeliness of the received reply, the responsiveness value increasing the likelihood that the at least one user profile is selected as a featured professional profile.

In a further embodiment of the system, the at least one processor is configured to communicate with a plurality of information sources external to the social networking service, obtain first information from a first external source of information selected from the plurality of sources of information, identify a predetermined set of features from the first information, at least one feature selected from the predetermined set of features corresponding to at least one user attribute used in defining a user profile maintained by the social networking service, and determine whether the first information qualifies as a predetermined event selected from the one or more predetermined events based on a comparison of at least one feature with at least one user attribute selected from at least one user profile selected from the first plurality of user profiles. Furthermore, the at least one processor is further configured to adjust the achievement value associated with the at least one user profile based on the performed determination.

This disclosure also provides for a method that includes analyzing, by at least one processor, a first plurality of user profiles maintained by a social networking service to determine whether a user associated with a user profile selected from the first plurality of user profiles has accomplished one or more predetermined events selected from a plurality of predetermined events, and assigning, by the at least one processor, an achievement value to each of the first plurality of user profiles, an achievement value corresponding to a user profile being determined based on the determination of whether the user associated with the user profile has accomplished the one or more predetermined events. The method also includes ranking, by the at least one processor, a second plurality of user profiles selected from the first plurality of user profiles, the ranking being performed according to the achievement value assigned to a corresponding user profile, and selecting, by the at least one processor, at least one user profile from the second plurality of ranked user profiles to be a featured professional profile, the selection based on a threshold value defining a number of user profiles that are to be considered featured professional profiles. Finally, the method includes accessing, by the at least one processor, the social networking service to obtain profile information associated with the at least one featured professional profile, and causing, by the at least one processor, the display of the obtained profile information in a predetermined portion of a display in communication with a user device.

In another embodiment of the method, the method includes obtaining a geographic location associated with each of the user profiles selected from the first plurality of user profiles, determining a geographic region associated with the obtained geographic locations, selecting the second plurality of user profiles from the first plurality of profiles according to the determined geographic region, and causing the display of the obtained profile information based on the determined geographic region.

In a further embodiment of the method, the method includes obtaining an industry associated with each of the user profiles selected from the second plurality of user profiles, selecting a third plurality of user profiles from the second plurality of user profiles based on the industry associated with a corresponding user profile, and ranking the third plurality of user profiles selected from the second plurality of user profiles, the ranking being performed according to the achievement value assigned to a corresponding user profile.

In yet another embodiment of the method, the method includes causing the display of a third plurality of user profiles on the user device, the third plurality of user profiles being selected from the first plurality of user profiles based on the third plurality of user profiles being connected to a member profile that the third plurality of user profiles have in common, and receiving a nomination for at least one user profile selected from the third plurality of user profiles from a user represented by the common member profile, the nomination indicating a preference for the at least one user profile to be a featured professional profile.\

In yet a further embodiment of the method, the second plurality of user profiles includes the third plurality of user profiles and the method further comprises ranking the second plurality of user profiles according to the received nomination.

In another embodiment of the method, the method includes sending a message to a user associated with the selected at least one user profile to be featured as the featured professional profile, the message indicating the selection of the at least one user profile to be featured as the featured professional profile, receiving a reply from the user, the reply indicating a willingness by the user to have the at least one user profile be featured as the featured professional profile, and assigning a responsiveness value to the at least one user profile based on the timeliness of the received reply, the responsiveness value increasing the likelihood that the at least one user profile is selected as a featured professional profile.

In a further embodiment of the method, the method includes communicating with a plurality of information sources external to the social networking service, obtaining first information from a first external source of information selected from the plurality of sources of information. identifying a predetermined set of features from the first information, at least one feature selected from the predetermined set of features corresponding to at least one user attribute used in defining a user profile maintained by the social networking service, determining whether the first information qualifies as a predetermined event selected from the one or more predetermined events based on a comparison of at least one feature with at least one user attribute selected from at least one user profile selected from the first plurality of user profiles, and adjusting the achievement value associated with the at least one user profile based on the performed determination.

In addition, this disclosure describes a machine-readable medium storing computer-executable instructions that, when executed by one or more processors, cause the one or more processors to perform a method, the method including analyzing, by at least one processor, a first plurality of user profiles maintained by a social networking service to determine whether a user associated with a user profile selected from the first plurality of user profiles has accomplished one or more predetermined events selected from a plurality of predetermined events, assigning, by the at least one processor, an achievement value to each of the first plurality of user profiles, an achievement value corresponding to a user profile being determined based on the determination of whether the user associated with the user profile has accomplished the one or more predetermined events, and ranking, by the at least one processor, a second plurality of user profiles selected from the first plurality of user profiles, the ranking being performed according to the achievement value assigned to a corresponding user profile. The method also includes selecting, by the at least one processor, at least one user profile from the second plurality of ranked user profiles to be a featured professional profile, the selection based on a threshold value defining a number of user profiles that are to be considered featured professional profiles, accessing, by the at least one processor, the social networking service to obtain profile information associated with the at least one featured professional profile, and causing, by the at least one processor, the display of the obtained profile information in a predetermined portion of a display in communication with a user device.

In another embodiment of the machine-readable medium, the method further includes obtaining a geographic location associated with each of the user profiles selected from the first plurality of user profiles, determining a geographic region associated with the obtained geographic locations, selecting the second plurality of user profiles from the first plurality of profiles according to the determined geographic region, and causing the display of the obtained profile information based on the determined geographic region.

In a further embodiment of the machine-readable medium, the method further includes obtaining an industry associated with each of the user profiles selected from the second plurality of user profiles, selecting a third plurality of user profiles from the second plurality of user profiles based on the industry associated with a corresponding user profile, and ranking the third plurality of user profiles selected from the second plurality of user profiles, the ranking being performed according to the achievement value assigned to a corresponding user profile.

In yet another embodiment of the machine-readable medium, the method further includes causing the display of a third plurality of user profiles on the user device, the third plurality of user profiles being selected from the first plurality of user profiles based on the third plurality of user profiles being connected to a member profile that the third plurality of user profiles have in common, and receiving a nomination for at least one user profile selected from the third plurality of user profiles from a user represented by the common member profile, the nomination indicating a preference for the at least one user profile to be a featured professional profile.

In yet a further embodiment of the machine-readable medium, the second plurality of user profiles includes the third plurality of user profiles and the method further comprises ranking the second plurality of user profiles according to the received nomination.

In another embodiment of the machine-readable medium, the method further includes sending a message to a user associated with the selected at least one user profile to be featured as the featured professional profile, the message indicating the selection of the at least one user profile to be featured as the featured professional profile, receiving a reply from the user, the reply indicating a willingness by the user to have the at least one user profile be featured as the featured professional profile, and assigning a responsiveness value to the at least one user profile based on the timeliness of the received reply, the responsiveness value increasing the likelihood that the at least one user profile is selected as a featured professional profile.

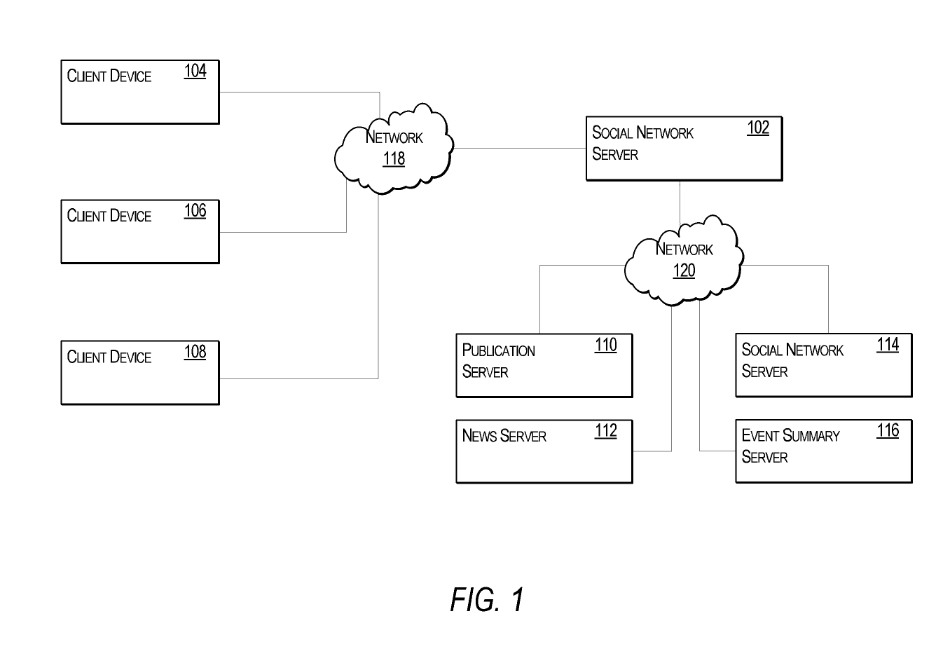

FIG. 1 is a block diagram illustrating a social network server 102 in communication with various client devices 104-108 and external information sources 110-116 in accordance with an example embodiment. The social network server 102 provides server-side functionality via a network 118 (e.g., the Internet or wide area network (WAN)) to one or more client devices 104-108. The one or more client devices 104-108 are configured to execute one or more types of clients to access the social network server 102, such as a web client (e.g., a browser, such as the Internet Explorer® browser developed by Microsoft® Corporation of Redmond, Wash. State), an application, or a programmatic client.

The client devices 104-108 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the social network server 102. In some embodiments, the client devices 104-108 may comprise a display module (not shown) to display information (e.g., in the form of user interfaces). In further embodiments, the client devices 104-108 may comprise one or more of a touch screens, accelerometers, gyroscopes, cameras, microphones, global positioning system (GPS) devices, and so forth. The client devices 104-108 may be a device of a user that is used to access a member profile (e.g., a user profile) associated with the user and maintained by the social network server 102.

In one embodiment, the social network server 102 is a network-based publication platform that responds to requests for user profiles maintained by the social networks server 102, publishes content relating to the various members of the social networking service, and manages updates and/or revisions to the user profiles.

One or more users of the client devices 104-108 may be a person, a machine, or other means of interacting with the client devices 104-108. In various embodiments, the users of the client devices 104-108 are not part of the network architecture shown in FIG. 1, but may interact with social network server 102 via the client devices 104-108 or another means. For example, one or more portions of network 118 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 104-108 may include one or more applications (also referred to as “apps”) such as, but not limited to, a web browser, messaging application, electronic mail (email) application, a social networking application, and the like. In some embodiments, if the social networking application is included in a given one of the client devices 104-108, then this application is configured to locally provide the user interface and at least some of the functionalities with the application configured to communicate with the social network server 102, on an as needed basis, for data and/or processing capabilities not locally available. Conversely if the social network application is not included in one or more of the client devices 104-108, the client devices 104-108 may use its web browser to access the social networking service hosted on the social network server 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

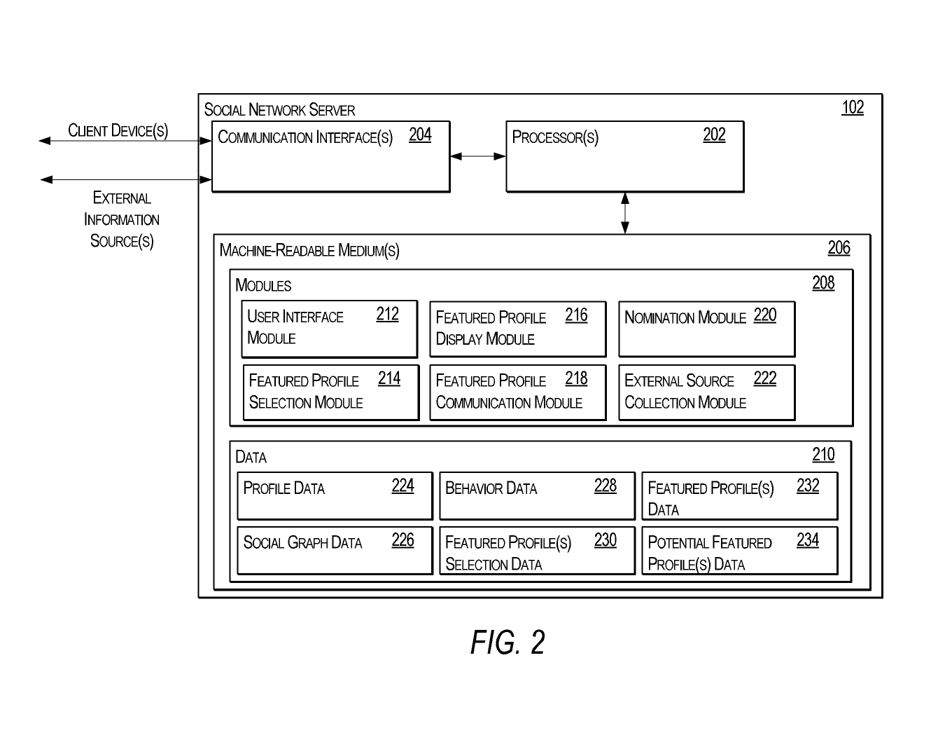

The social network server 102 also communicates with one or more external sources of information 110-116. In one embodiment, the external sources of information 110-116 provide an interface for accessing the information retained by the respective information source. The external sources of information 110-116 may include, but are not limited to, a publication server 110, a news server 112, another social network server 114, and an event summary server 116. Other external sources of information may also include an electronic marketplace, a software publication marketplace, an event monitoring website, a photography website, an audio publication website, a video publication website, and other such external sources of information. The social network server 102 may communicate with the external sources of information 110-116 via a network 120, which may include one or more of the networks of network 118 or a different set of networks (e.g., one or more combinations of wired and/or wireless networks). The information obtained by the social network server 102 from the external sources of information 110-116 may include text, graphics, audio, or combinations thereof, in one or more formats, such as HTML, PDF, MP3, WAV, MP4, AVI, or other such electronic formats. As discussed below with reference to FIG. 2, the social network server 102 may analyze the obtained information to determine whether a member profile retained by the social network server 102 should be designated as a featured professional profile.

FIG. 2 is a block diagram illustrating the components of the social network server 102 of FIG. 1 in accordance with an example embodiment. In one embodiment, the social network server 102 includes one more communication interfaces 204 in communication with one or more processors 202. The one or more processors 202 are communicatively coupled to one or more machine-readable mediums 206, which include modules 208 for selecting and displaying a featured professional profile from the social networking service and data 210 to support the execution of the modules 208.

The various functional components of the social network server 102 may reside on a single device or may be distributed across several computers in various arrangements. The various components of the social network server 102 may, furthermore, access one or more databases, and each of the various components of the social network server 102 may be in communication with one another. Further, while the components of FIG. 2 are discussed in the singular sense, it will be appreciated that in other embodiments multiple instances of the components may be employed.

The one or more processors 202 may be any type of commercially available processor, such as processors available from the Intel Corporation, Advanced Micro Devices, Texas Instruments, or other such processors. Further still, the one or more processors 202 may include one or more special-purpose processors, such as a Field-Programmable Gate Array (FPGA) or an Application Specific Integrated Circuit (ASIC). The one or more processors 202 may also include programmable logic or circuitry that is temporarily configured by software to perform certain operations. Thus, once configured by such software, the one or more processors 202 become specific machines (or specific components of a machine) uniquely tailored to perform the configured functions and are no longer general-purpose processors.

The one or more communication interfaces 204 are configured to facilitate communications between the social network server 102, the various client devices 104-108, and the external information sources 110-116. The one or more communication interfaces 204 may include one or more wired interfaces (e.g., an Ethernet interface, Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combination of such wired and wireless interfaces.

The machine-readable medium 206 includes various modules 208 and data 210 for selecting and providing a featured professional profile for display by one or more of the client devices 104-108. The machine-readable medium 206 includes one or more devices configured to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as a “cloud-based” storage systems or storage networks that include multiple storage apparatus or devices. As shown in FIG. 2, the machine-readable medium 206 excludes signals per se.

In various embodiments, the modules 208 include a user interface module 212, a featured profile selection module 214, a featured profile display module 216, a featured profile communication module 218, a nomination module 220, and an external source collection module 222.

The user interface module 212 is configured to provide a user interface, such as a graphical user interface, to the one or more client devices 104-108 for interacting with the social network server 102. In one embodiment, the user interface module 212 provides the graphical user interface via a programmatic client installed on the one or more client devices 104-108. In another embodiment, the user interface module 212 provides the graphical user interface via a web service accessible by a web browser installed on the one or more client devices 104-108. The graphical user interface provided by the user interface module 212 facilitates interactions between a user of the one or more client devices 104-108 and the social networking service provided by the social network server 102. These interactions include, but are not limited to, building a member profile, communicating with other members of the social networking service (e.g., via e-mail or other communication medium), establishing connections with the user's member profile and other member profiles, recommending other members as connections, nominating other members as a featured professional, and other such interactions.

In one embodiment, the user interface module 212 leverages the profile data 224 and the social graph data 226 stored by the machine-readable medium 210 in presenting a graphical user interface to the user of the one or more client devices 104-108. In one embodiment, the profile data includes personal information provided by a member and employment history for the member. The personal information may include, but is not limited to, the member's name, contact information, photographs, personal messages, status information, multimedia, links to web-related content, blogs, the member's educational history (e.g., previous schools that were attended and/or degrees that were obtained), and other such personal information. The employment history for the member may include, but is not limited to, the member's current employer, the member's prior employers, the member's current position and/or job function, the member's past positions and/or job functions, and other such employment history information. Further still, the profile data 224 includes skills that the member has indicated as possessing (e.g., technical skills, legal writing skills, programming skills, etc.), and endorsements by other members of the social networking service of those skills. In addition, the profile data 224 is encrypted and/or securely stored such that access to the profile data 224 is unauthorized unless specifically granted by the member.

While profile data 224 has been described with regard to an individual as a member, a member may also include organizations, such as for-profit companies and non-profit organizations. In this regard, where the member is an organization, the profile data 224 includes information relevant to the organization, such as the number of members in the organization, the products and/or services provided by the organization, the officers of the organization, publicly accessible updates about the organization provided to other members of the social networking service, and other such profile data 224.

The social graph data 226 includes information about how a given member is connected to any other member of the social networking service. In one embodiment, the social graph data 226 includes nodes, which represent members (e.g., organizational members and individual members), and the edges between the nodes represent a connection between members. For example, an individual member node may be directly connected (e.g., without intervening nodes) to an organizational node where the member associated with the individual member node indicates that he or she was previously employed by the organization represented by the organizational member node. Similarly, a first individual member node may be directly connected to a second, individual member node where the first member indicates that he or she knows the second member. In one embodiment, establishing a direct connection between nodes is accomplished by a requesting member to be connected with the non-requesting member. The non-requesting member may then confirm that the requesting member be directly connected to him, her, or it.

As the social graph data 226 is a graph, member nodes may be indirectly connected to other member nodes. In other words, there may be a degree of separation between nodes depending on the number of intervening nodes inbetween. For example, where there is one intervening node between a first node and a second node (e.g., the first node and the second node have the intervening node in common), the second node is considered a 2^{nd}-degree connection of the first node (and vice versa). As a general concept, each intervening node between a first node and a second node increases the degree of separation between the first node and second node by one.

A connection between nodes represents or is otherwise associated with an information access privilege, such that a first member who has established a connection with a second member, via the establishment of that connection, authorizing the second member to view or access certain non-publicly available portions of the first member's profile, which may include communications that the first member has published or has otherwise authored. Example communications may include blog posts, messages, “wall” postings, or the like. Further still, the social networking service may include varying types of access privileges such that the first member can restrict the second member from having access to certain types of content. In one embodiment, the access privileges are implemented as a binary decision (e.g., “affirmative” or “negative”), indicating whether the second member has access to a particular content or set of content that the first member has authored, or provided to, the social networking service.

In addition to the profile data 224 and the social graph data 226, the social network server 102 may have access to, or implement, behavior data 228 for one or more of the members of the social networking service. In one embodiment, the behavior data 228 includes information about how one or more members of the social networking service interact with it and other members. For example, behavior data 228 may include updates submitted by a member (e.g., an individual and/or organizational member) and disseminated to other members, whether a member viewed or took an action on an update provided by another member, whether a member established a connection with another member, how a member established a connection with another member, and other such behavior data. As to updates (e.g., status updates) provided by members, the social network server 102 via the user interface module 212 may distinguish between a “view” and an “impression.” A “view” occurs where a given member simply views an update provided by another member; in contrast, an “impression” occurs where a member takes an action (e.g., indicates an agreement with the update, comments on the update, shares the update with other members, etc.) on the update. Further still, the social network server 102 is configured to monitor actions with regard to other content that a member may provide via the social networking service, such as available job postings (e.g., whether a member applied for a job offered by another member), offered products and/or services, changes in status (e.g., where a member indicates that he or she has changed positions or employers), whether a member has endorsed a skill listed by another member, and other such actions. Such monitoring and recording may be implemented by a variety of client-side and/or server-side technologies, such as JavaScript, PHP, ColdFusion, Ruby on Rails, Dynamic HTML, and other such technologies.

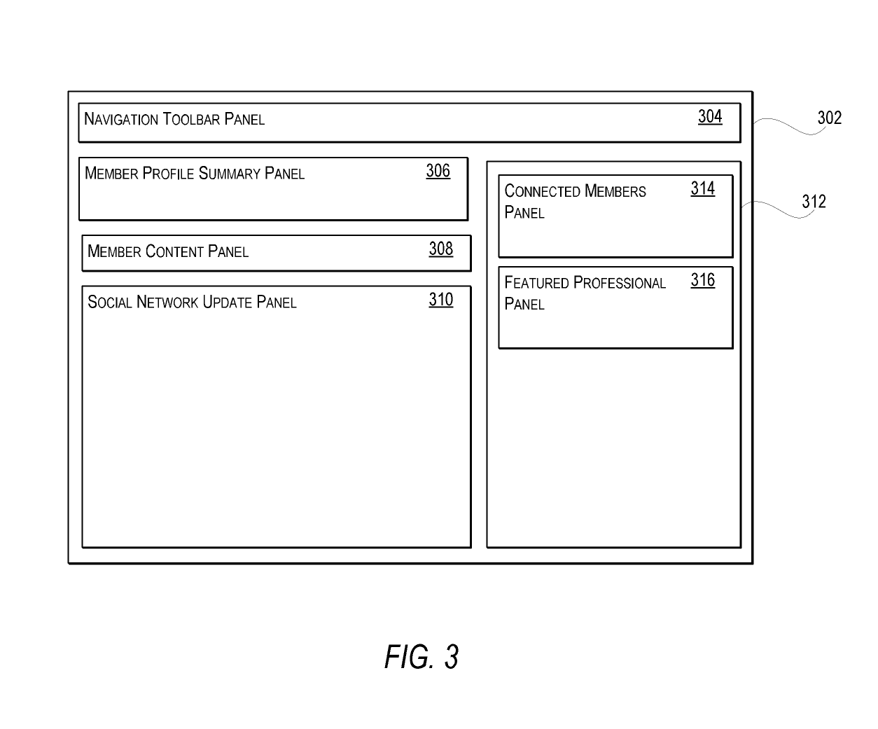

In presenting a user interface to a member of the social networking service, the displayed interface may include a variety of panels having a distinct set of content for display and interaction with the member. FIG. 3 is a block diagram illustrating the panels 304-316 of a user interface 302, according to an example embodiment, for interacting with the social network server 102. In one embodiment, the user interface 302 includes a navigation toolbar panel 304, a member profile summary panel 306, a member content panel 308, a social network update panel 310, and a sidebar content panel 312, which may include various sidebar panels, such as a connected members panel 314 and a featured professional profile panel 316.

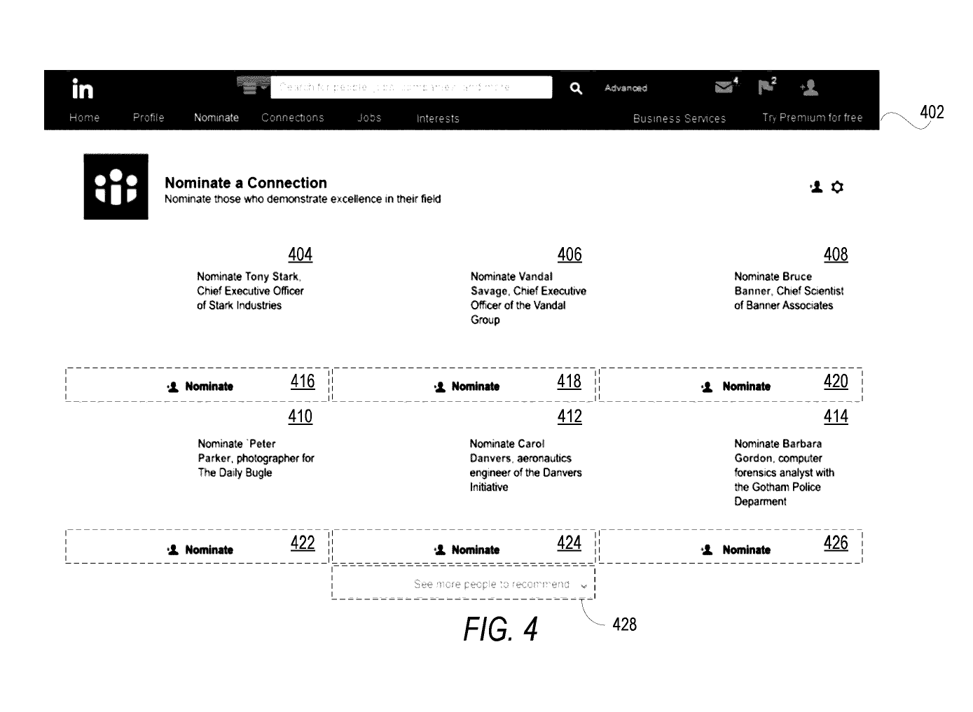

The navigation toolbar panel 304 is configured to facilitate navigation through the various webpages and/or user interfaces provided by the social network server 102. As discussed below with reference to FIG. 4, the navigation toolbar panel 304 includes graphical and/or textual elements representing hyperlinks that the user selects to navigate the various webpages and/or user interfaces provided by the social network server 102 (e.g., via the user interface module 212). The member profile summary panel 306 includes a summary about the member having accessed the social networking service, which may be displayed when the member first accesses the social networking service, but it may also include a summary about a second member when the second member's profile is selected. In one embodiment, the user interface module 212 retrieves profile data 224 to populate the member profile summary panel 306. For example, the profile data 224 may be instantiated as a set of key/value pairs, where a key corresponds to a member attribute (e.g., name, job function, employer, etc.) and the value corresponds to the value of the attribute, and a set of key/value pairs may be designated for populating the various portions of the member profile summary panel 306.

The member content panel 308 includes one or more elements, such as graphical and/or textual elements, that a member interacts with to provide content to the social networking service. These elements may be further associated with the behavior data 228, such that selections or interactions with the elements produce corresponding changes in the behavior data 228. As shown in FIG. 4, and in one embodiment, the elements displayed in the member content panel 308 includes an update element, an uploading element, and a publishing element. When the update element is selected, the member can provide information, such as anything the member has recently accomplished, news articles that may be of interest to the member, and other such information, which is then disseminated to other members of the social networking service. Similarly, when the upload element is selected, the member can upload an electronic image (or other electronic information) for dissemination to the other members of the social networking service. Finally, when the publishing element is selected, the member can provide a journal article that he or she composes, which is then disseminated to the other members of the social networking service.

The members that receive the various types of information provided via the member content panel 308 is determined by the social graph data 226. In one embodiment, the social network server 102 determines which members receive the update information based on the degree of connectedness in the social graph data 226. For example, members that are directly connected to the member providing the information may receive as content for display via the user interface 302 (e.g., via the social network update panel 310), whereas members that are more than directly connected (e.g., 2nd-degree connections, 3rd-degree connections, etc.) may not receive the member-provided information.

Accordingly, the social network update panel 310 displays information members provide via the member content panel 308. The content displayed in the social network update panel 310 may include, but is not limited to, member update information, changes to a member's profile, changes to a member's educational or employment history, member announcements (e.g., product and/or service announcements), awards or recognitions received by a given member, and other such content.

The sidebar content panel 312, implemented by the user interface module 212, provides content to the member that is secondary content, but nonetheless may be relevant to the member. In that regard, the sidebar content panel 312 includes the connected members panel 314 and the featured professional profile panel 316. The connected members panel 314 displays information about members that are connected to the member using the user interface 302. In one embodiment, the member profiles (or summary of member profiles) displayed in the connected members panel 314 are limited by a threshold level of connectedness (e.g., directly connected members, 2nd-degree members, 3rd-degree members, etc.). The information displayed in the connected members panel 314 may include such information as reminders to the member about an important date or anniversary for the member displayed in the connected members panel 314, suggested connections for the member (e.g., suggestions to establish a direct connection with another member), and other such information.

The featured professional profile panel 316 displays information about a featured member. In one embodiment, the selection of the featured member is implemented by the featured profile selection module 214. The featured profile selection module 214 selects a member from the social networking service to be “featured,” e.g., displayed within the featured professional profile panel 316 such that the featured profile is seen by various members of the social networking service.

The featured profile selection module 214 leverages different sets of data and metrics in selecting a featured professional. For example, the featured profile selection module 214 may leverage one or more of the profile data 224, the social graph data 226, and/or the behavior data 228. As the featured profile selection module 214 extracts and/or obtains data from the various data sets 224-228, the featured profile selection module 214 may then store that data as the featured profile selection data 230 for faster retrieval or later accessibility.

To determine whether a profile from the social networking service should be included within the group of profiles under consideration, the featured profile selection module 214 may extract the profile data 224 and/or behavior data 228 associated with a given profile. Profiles under consideration to be a featured profile may be associated with a predetermined or assigned identifier, and the identifier may be stored in the potential featured profile data 234. In this way, the potential featured profile data 234 includes a list of profiles that have been selected as profiles under consideration to be a featured profile.

In one embodiment, the featured profile selection module 214 first selects a predetermined number of profiles to be considered as a featured professional profile. The predetermined number may be based on a threshold amount, such as an absolute number (e.g., 200) or percentage (e.g., 2%). As an example, the featured profile selection module 214 may select the top 200 member profiles having met one or more criterions, such as a threshold number of views, a threshold number of impressions, a threshold number of endorsements, a threshold number of published posts, and other such criterion.

Further still, the featured profile selection module 214 can be configured to select the predetermined number of profiles to be considered as a featured professional profile at predetermined time intervals having met the one or more criterions within a given time period. For example, the featured profile selection module 214 may select the top 200 profiles having the most number of views within a two-week period prior to a given date (e.g., Jan. 14, 2015). As another example, the featured profile selection module 214 may select the top 400 profiles having the most number of views and the most number of updates within a four-week period prior to Feb. 15, 2015. As evident in these examples, there are many different combinations by which the featured profile selection module 214 may select a profile to be considered as a featured professional profile.

In addition, the featured profile selection module 214 may select various subsets of profiles for consideration as a featured profile according to a geographic region and/or industry associated with a given profile. In one embodiment, for each geographic region G_{i=1 . . . n}, where n is the number of regions defined by the social networking service, the featured profile selection module 214 selects a corresponding set of profiles for consideration as a featured profile associated with the corresponding region Gᵢ. The geographic region Gᵢ may be obtained from the profile data 224, and may be the geographic region of an employer associated with a given profile or a geographic region provided by the member associated with the given profile. Further still, the geographic region Gᵢ may represent a set of geographic locations, such that different locations located within the same region are grouped accordingly (e.g., cities within the same state are grouped by the state represented by Gᵢ).

In addition, the profiles under consideration to be a featured profile may be grouped by industry, represented by I_{j=1 . . . m}, where m is the number of industries defined by the social networking service. In one embodiment, the industry Iⱼ associated with a given member profile is the industry of the current employer for the member associated with the given member profile. Alternatively, where no employer is listed, the industry may be a skill that the given member lists as possessing or it may be an industry corresponding to the job function identified by the member associated with the given member profile.

Furthermore, depending on the level of granularity desired by the operator of the social network server 102, each geographic region Gᵢ may have a corresponding set of industries Iⱼ, where each industry Iⱼ for each geographic region Gᵢ includes a set of member profiles under consideration as a featured professional profile. Thus, regardless of the industry and/or geographic region associated with a given member profile, the featured profile selection module 214 is configured to select a featured professional profile for the given member profile.

Once the initial set of profiles are selected for consideration as a featured profile, the featured profile selection module 214 then extracts achievement or event data associated with the profiles under consideration for further evaluation and refinement. In other words, the initial set of profiles are ranked so as to identify those profiles likely to garner more attention than other profiles. In one embodiment, the featured profile selection data 230 defines various events and/or achievements used by the featured profile selection module 214. As the profile data 224 for a given member is associated with an attribute, so too may that attribute be designated as an achievement or as an event. Thus, in one embodiment, one or more attributes that comprise the profile data 224 are used by the featured profile selection module 214 in determining whether a given member profile should be designated as a featured professional profile.

Below is a list of example events and/or achievements that may be considered by the featured profile selection module 214:
whether the member is an inventor listed on a patent or published patent application;
a skill listed by the member;
a change in employment where the change results in a promotion or other advancement;
an added volunteering experience;
a new project or other undertaking listed by the member;
a nomination by another member (discussed below rather reference to FIG. 4); and,
a positive or neutral mention in a publication external to the social networking service.

The foregoing list is merely illustrative and not meant to be exhaustive. Alternative embodiments of the disclosed social network server 102 may include additional or alternative sets of events and/or achievements that may be considered by the featured profile selection module 214.

For each member profile under consideration to be a featured profile (e.g., the member profiles listed in the potential featured profile data 234), the featured profile selection module 214 determines an associated achievement value. In one embodiment, the achievement value for a corresponding member profile is merely the summation of the number of views the member profile has received and a count of the number of events identified by the featured profile selection module 214. However, alternative embodiments of the featured profile selection module 214 may include different or more complex methods of determining the achievement value. For example, the achievement value may be represented by Σᵢ₌₁ⁿxᵢ+Σⱼ₌₁^{m}yⱼ where xᵢ is a behavior attribute associated with the given member profile (n being the number of defined behavior attributes, each behavior attribute being assigned a predetermined value) and yⱼ is an achievement or event associated with the given member profile (m being the number of defined achievements and/or events, where each achievement and/or event is assigned a predetermined value). Examples of behavior attributes include the number of views the given member profile has received, the number of impressions the given member profile has received, the number of updates or publications the member associated with the given member profile has provided, the number of uploads associated with the given member profile, and other such behavior attributes (e.g., attributes that are stored as part of the behavior data 228). Further still, each of the xᵢ and/or yⱼ may be associated with a predetermined weighting factor such that different behavior attributes are weighted differently and different events and/or achievements are weighted differently. By implementing a weighting factor, the featured profile selection module 214 can assign more significance to certain events (e.g., being listed as an inventor on a patent application) than to other events (e.g., adding a new volunteering experience).

After the various profiles under consideration have been assigned a corresponding achievement value, the featured profile selection module 214 may then further select a threshold number of profiles as profiles ready to be featured. For example, the featured profile selection module 214 may select the top five profiles under consideration or the top 2% of profiles under consideration as profiles ready to be featured. For each of the profiles ready to be featured, the featured profile selection module 214 may invoke the featured profile communication module 218, which is configured to send a message or other communication to the member associated with a given member profile. The featured profile communication module 218 is further configured to receive responses to such a communication, which may be stored as featured profile data 232 and/or potential featured profile data 234.

In one embodiment, the message communicated to a member associated with a profile ready to be featured is displayed via the user interface 302. Alternatively, the message may be communicated via other electronic means, such as an e-mail message or Short Messaging Service (SMS) message. The message notifies the recipient of his or her candidacy to be a featured professional, and further includes a message to the recipient asking him or her to confirm that he or she would like to be a featured professional. The message may further include a request that the member provide a brief description of a notable achievement to be included in the featured professional profile summary and displayed via the featured professional panel 316.

As it is desirable to feature a given member profile soon after the profiles ready to be featured have been selected (e.g., to reduce the likeliness that the information used to determine the profiles ready to be featured becomes stale), the featured profile selection module 214 is configured to implement a responsiveness value, which is directly proportional to the likelihood that a given member profile is to be featured as a featured professional profile. In one embodiment, the responsiveness value is assigned a first value representing the number of profiles to be featured (e.g., five) and the first value is decremented by a second value (e.g., one, 0.5, or other such value) each time a reply is received from a member associated with a member profile ready to be featured. If no reply is received after a predetermined time period (e.g., a day, a week, etc.), a default value (e.g., one) may be assigned to the responsiveness value.

In this manner, the member profile associated with the first member to reply to the communication from the featured profile communication module 218 is assigned the highest responsiveness value; in contrast, the member profile associated with the last member to reply is assigned the lowest responsiveness value. Similarly, a member profile associated with a member that does not reply is assigned the default value (which may be lower than the value assigned to the last member to reply). Accordingly, there is a lesser likelihood that the member profile associated with the last member to reply is selected as a featured professional profile.

To select the featured professional profile, the featured profile selection module 214 may simply select the member profile associated with the highest responsiveness value. In an alternative embodiment, the selection of the featured professional profile is implemented as a lottery, where the responsiveness value indicates the number of entries for a corresponding member profile, the total number of entries in the lottery is the summation of the number of entries for each corresponding member profile, and the featured profile selection module 218 randomly selects an entry from the total number of entries. In this alternative embodiment, member profiles associated with higher responsiveness values are more likely to be selected than member profiles associated with lower responsiveness values.

Recalling that one of the metrics used in the determination of the described achievement value is the number of nominations a given member profile receives, the nomination module 220 is configured to implement a user interface for receiving nominations from one or more members of the social networking service. FIG. 4 illustrates a user interface 402, according to an example embodiment, for nominating members to be a featured professional of a social networking service. In one embodiment, the nomination module 220 retrieves profile data for one or more member profiles 404-414 within a social graph of a given member, where such profile data is then displayed within the user interface 402 via the user interface module 212. For example, the member profiles 404-414 that are presented may be members that are connected to a given member by a predetermined degree (e.g., directly connected, 2nd-degree connections, 3rd-degree connections, etc.). Further still the member profiles 404-414 presented via the user interface 402 may be member profiles within the same geographic region as a given member or member profiles associated with one or more industries as the given member profile (e.g., determined from the profile data 224 via one or more comparisons).

The user interface 402 displays one or more nomination elements 416-426 that, when selected, cause a corresponding member profile to receive a nomination to be a featured professional profile. As shown in FIG. 4, the member profile 404 is associated with the nomination element 416, member profile 406 is associated with the nomination element 418, the member profile 408 is associated with the nomination element 420, the member profile 410 is associated with the nomination element 422, the member profile 412 is associated with the nomination element 424, and the member profile 414 is associated with the nomination element 426. When the nomination module 220 receives a nomination via one or more of the nomination elements 416-426, such nomination may be stored as profile data 224 and/or behavior data 228 for the associated member profile. Furthermore, such nominations may be additive, such that the nomination module 220 records the number of nominations a given profile receives during a predetermined time period (e.g., the predetermined time period from which featured professional profiles are determined). In this way, should one of the member profiles 404-414 be under consideration as a featured professional profile, the featured profile selection module 214 may retrieve the nomination value to be used in the determination of the corresponding achievement value. The user interface 402 further includes a request element 428 which, when selected, causes the user interface 402 (via the nomination module 220), to display additional member profiles to nominate.

In addition to nominations, the featured profile selection module 214 may leverage whether a given member is mentioned in an outside source as a metric for determining the corresponding achievement value for the corresponding member profile. Accordingly, the social network server 102 is configured to implement an external source collection module 222 configured to retrieve information from various sources external to the social network server 102. Referring back to FIG. 1, such external sources may include a publication server 110 (e.g., an online repository of journal articles), a news server 112, another social network server 114, or an event summary server 116 (e.g., a server that hosts websites for wedding announcements or a server that hosts a website summarizing the persons appearing in a television show or movie). In one embodiment, the external source collection module 222 is configured to retrieve the text from such external sources 110-116, and to identify various textual features of the retrieved text (e.g., nouns, verbs, direct objects, indirect objects, adjectives, adverbs, etc.) using one or more natural language processing techniques. The external source collection module 222 may then search the determined textual features for one or more attributes (e.g., a member profile name) associated with a given member profile under consideration as a featured professional profile.

Further still, where a textual feature is determined to correspond to a given member profile attribute (e.g., by comparing by the textual feature with the given member profile attribute), the external source collection module 222 may then determine the context in which the member profile attribute appears. For example, the textual features (e.g., adjectives, adverbs, other nouns, etc.) may indicate whether the member profile attribute appears in a positive or negative context. Where the textual features indicate that the member profile attribute appears in a positive context, the appearance of the member profile attribute increases the external source metric (e.g., the metric associated with external sources used in determining the achievement value associated with the given member profile) by a predetermined amount. In addition, other factors may alter and/or increase the value of the external source metric, such as the source of the textual features (e.g., national websites may increase the metric whereas local websites may not affect the metric), the author of the text in which the member profile attribute appears, the length of the text in which the member profile attribute appears, the number of times the member profile attribute appears, and other such factors.

Referring back to FIG. 2. and to the selection of the featured professional profile, the featured profile selection module 214 may store an identifier associated with a given member profile that was selected as a featured professional profile in the featured profile data 232. The identifier indicates that the given member profile was selected as a featured professional profile. Further still, the featured profile selection module 214 may reference the identifiers stored in the featured profile data 232 to initially filter out those member profiles that had already been selected as a featured professional profile. However, a predetermined time limit may be imposed on the identifiers in the featured profile data 232, such as a 1-year time limit, such that the expiration of the time limit causes the featured profile selection module 214 to remove the identifier from the featured profile data 232, thus allowing the associated member profile to be reconsidered as a featured professional profile. In an alternative embodiment, once a given member profile is selected as a featured professional profile, an identifier is associated with the given member profile such that the given member profile is no longer eligible to be a featured professional profile. In this manner, when the selection process begins for selecting a featured professional profile, the identifier signals that the given member should not be considered as a selection for the featured professional profile.

In addition, member profiles that were not selected as the featured professional profile may be placed in a queue (e.g., as a part of the potential featured profile data 234) such that, after a predetermined time period (e.g., a day, a week, a month, etc.), a member profile in the queue is selected as the featured professional profile. In this manner, various member profiles are placed in rotation as the featured professional profile.

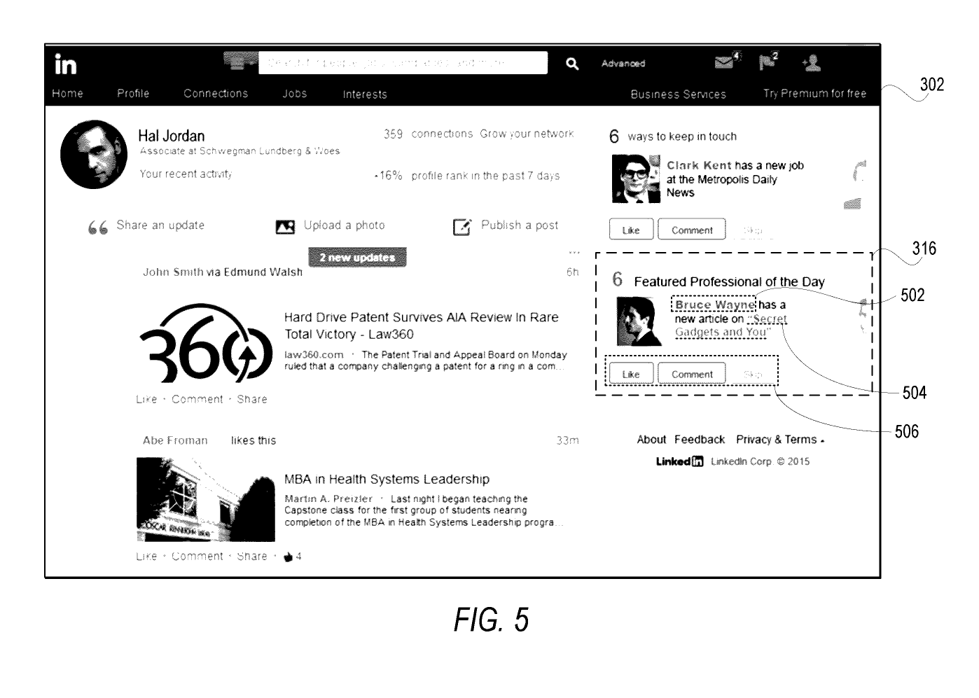

FIG. 5 illustrates the user interface 302, according to an example embodiment, for interacting with the social network server. As shown in FIG. 5, the featured professional panel 316 displays information about a featured professional. In one embodiment, the information about the featured professional is retrieved by the featured profile display module 216, which obtains the values of the member profile attributes to be displayed in the featured professional panel 316. In one embodiment, the information displayed in the featured professional panel 316 includes a first selectable element 502 that links to the member profile of the featured professional, a second selectable element 504 that links to a recent accomplishment (e.g., event, publication, or other accomplishment) by the featured professional, and a navigation toolbar 506, which includes various selectable elements by a member for interacting with the member profile displayed in the featured professional panel 316.

As discussed above, the member featured as the featured professional may be given the opportunity to highlight or briefly describe a recent accomplishment via the featured profile communication module 218. The description provided by the member may be reviewed prior to publication within the featured professional panel 316. As shown in FIG. 5, the member featured in the featured professional panel 316 has chosen to describe that he has recently published a new article, titled “Secret Gadgets and You.” In addition, the member has provided a hyperlink to the published article, which is displayed as the second selectable element 504.

The featured professional shown in FIG. 5 is also not the only member selected to be a featured professional. The featured professional panel 316 has been implemented as a carousel, such that other featured professionals may also be displayed. As denoted by the number “6” in the upper left hand corner of the featured professional panel 316, there are at least five other members that the featured profile display module 216 has determined would be suitable for displaying to the member associated with the profile shown in FIG. 5. These at least five other featured professionals may have been chosen based on having one or more profile data 224, social graph data 226, or behavior data 228 in common with the member profile, such as one or more connections in common, having a shared geography (e.g., location and/or region), having a shared or related industry with the member profile, or any combination of such profile attributes (e.g., having both a shared geographic region and industry).

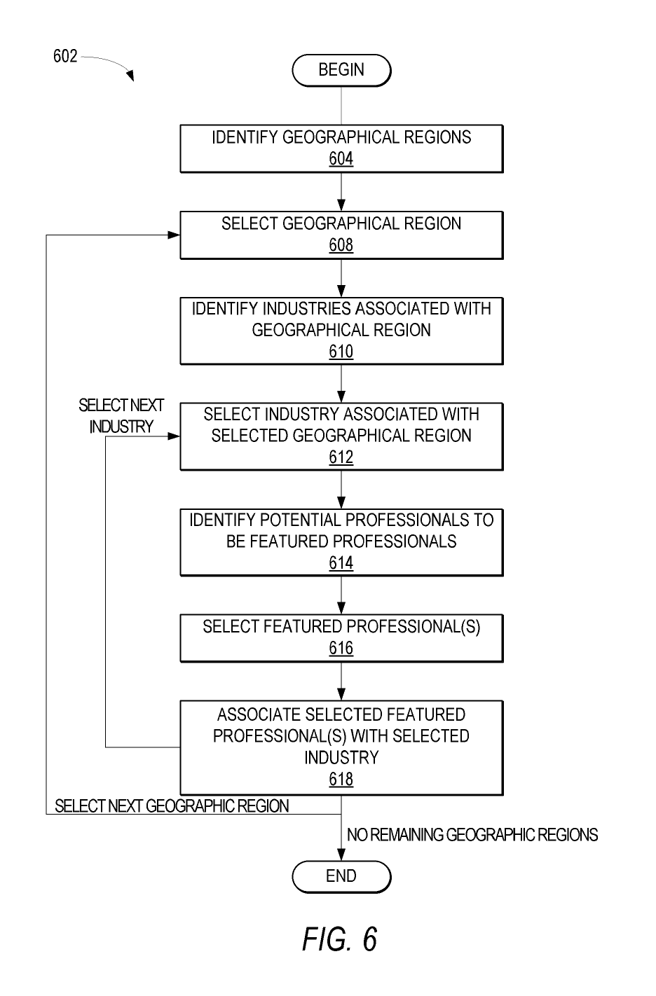

FIG. 6 illustrates logic flow 602 for selecting a member profile to be a featured professional profile according to an example embodiment. The logic flow 602 shown in FIG. 6 presumes that a featured professional profile is being selected for a given industry within a geographic region and/or location. However, it will be evident to one of ordinary skill in the art that a featured professional profile could be selected from among the member profiles of the social networking service by omitting one or more of the operations shown in FIG. 6, such as by omitting the selection of the geographical region (Operation 608) and/or by omitting the selection of a given industry (Operation 612).

Initially, one or more geographical regions are identified and/or designated (Operation 604). As discussed previously, the featured profile selection module 214 may identify geographical regions by obtaining geographical locations associated with one or more member profiles from the profile data 224.

A first geographical region from the set of geographical regions is then selected (Operation 608). The featured profile selection module 214 then receives and/or identifies one or more industries associated with the selected geographical region (Operation 610). As discussed above, a given industry may be identified by obtaining and/or extracting an industry associated with one or more member profiles associated with the geographical region from the profile data 224, and then grouping (e.g., clustering) one or more member profiles having the extracted industry.

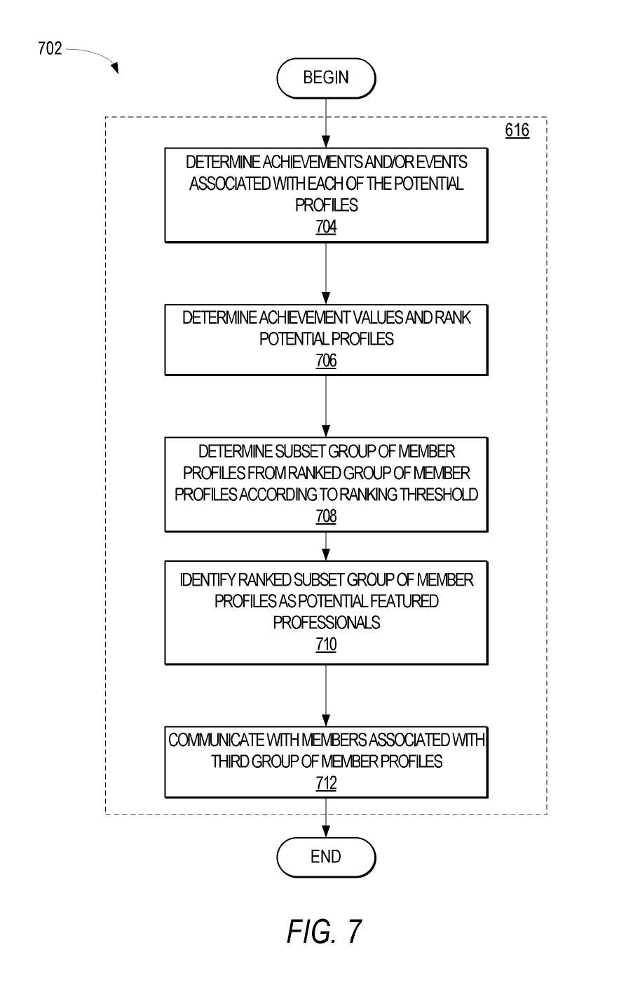

The featured profile selection module 214 then selects an industry from the identified industries associated with the selected geographical region (Operation 612). For each member profile associated with the selected industry (e.g., as indicated by the profile data 224), the featured profile selection module 214 selects an initial set of member profiles to be considered a featured professional profile (Operation 614). As discussed above, such initial selection may be based on whether a given profile has received a threshold number of profile views within a predetermined time period. As discussed with reference to FIG. 7, the featured profile selection module 214 then selects one or more featured professional profiles (Operation 616). The featured profile selection module 214 then associates with selected featured professional profiles with the selected industry (Operation 618), and then proceeds to the next industry in the group of industries associated with the geographic region. When the industries associated with the geographic region have been exhausted, the featured profile selection module 214 then selects the next geographic region from the group of geographic regions. When there are no remaining geographic regions remaining, the featured profile selection module 214 then completes the identification and determination of the one or more featured professional profiles.

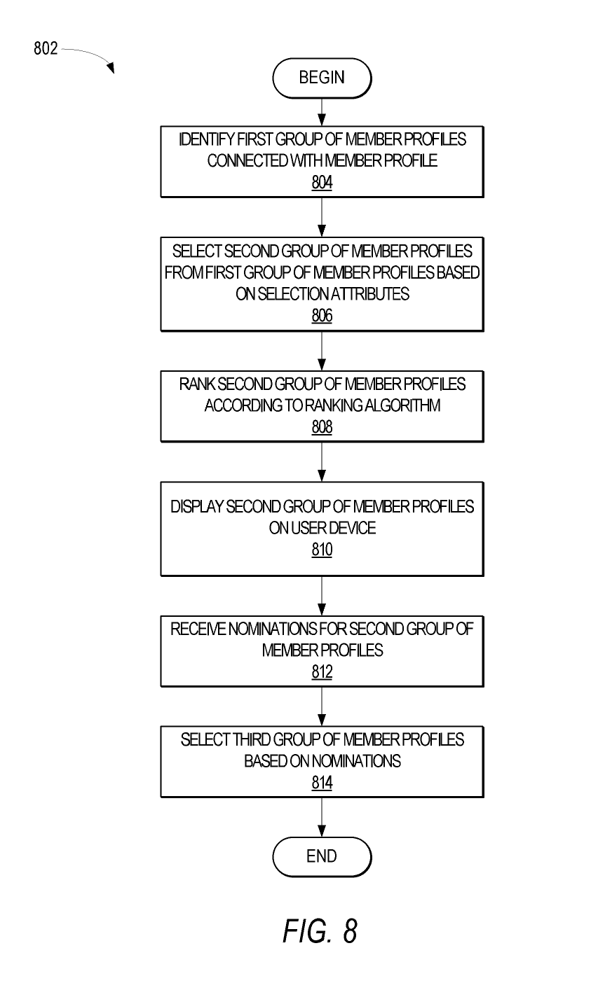

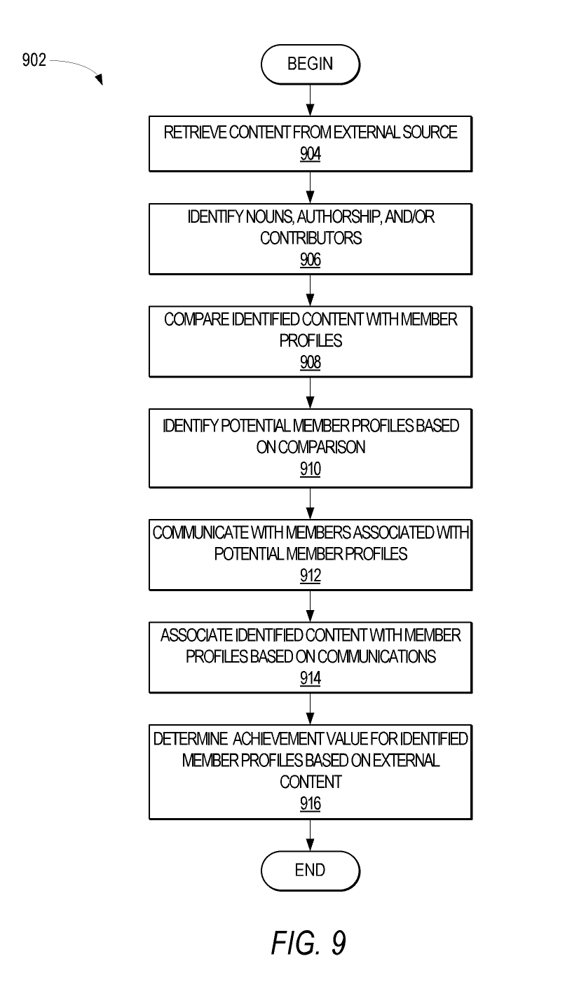

FIG. 7 illustrates additional logic flow 702 for selecting the member profile to be a featured professional profile according to an example embodiment. The logic flow 702 may be implemented by the featured profile selection module 214 as the Operation 616 for selecting a featured professional profile. Initially, featured profile selection module 214 determines those achievements and/or events that are associated with a given member profile (Operation 704). As discussed previously, such achievements and/or events may include, but are not limited to, being listed as an inventor on a patent or published patent application, having a listed one or more skills or one or more particular skills, identifying a change in employment where the change results in a promotion or other advancement, adding a volunteering experience, listing a new project or other undertaking, having one or more nominations by another member (discussed below with reference to FIG. 8), or having one or more positive or neutral mentions in a publication external to the social networking service (discussed below with reference to FIG. 9).

After the achievements and/or events have been determined, the featured profile selection module 214 then determines an achievement value for each of the member profiles under consideration to be a featured member profile (Operation 706). Thereafter, the featured profile selection module 214 employs a ranking threshold (e.g., an absolute number, a percentage, etc.) to determine a ranked subset of member profiles (Operation 708), and then identify the ranked subset of member profiles as potential featured member profiles (Operation 710). The featured profile communication modules 218 then sends out a communication to the members associated with the potential featured member profiles inquiring whether the member desires to be identified as a featured professional profile (Operation 712). As discussed above, the reply from the member increases the likelihood that the member will be selected as the featured professional.

FIG. 8 illustrates logic flow 802 for receiving nominations for a member profile to be a featured professional profile according to an example embodiment. Initially, the featured profile selection module 214 identifies those connections (e.g., other member profiles) connected to a given member profile (Operation 804). The featured profile selection module 214 then selects those connections that would be suitable candidates for being a featured professional. In one embodiment, the featured profile selection module 214 may leverage an achievement value threshold, and compare corresponding achievement values for the identified connections with the achievement value threshold. The featured profile selection module 214 may then rank one or more of the member profiles associated with achievement values that meet or exceed the achievement value threshold (Operation 808). The ranking may be performed based on the achievement value associated with the member profiles. The featured profile selection module 214 then selects a predetermined number or percentage of ranked member profiles, which it then communicates to the nomination module 220. The nomination module 220 then communicates one or more of the ranked member profiles to a user device, which may be displayed via a user interface (e.g., user interface 402). The nomination module 220 then receives nominations (e.g., via elements 416-426) of the displayed member profiles (Operation 812). The featured profile selection module 214 may then select one or more of the member profiles receiving nominations to be considered as a featured professional profile based on a nomination threshold, such as the top 2% of member profiles that received nominations (Operation 814).

FIG. 9 illustrates logic flow 902, according to an example embodiment, for obtaining external information to be used in determining whether a member profile should be selected as a featured professional profile. As discussed above, the external source collection module 222 collections information (e.g., textual information) from one or more external sources, such as a website hosting journal articles, a website hosting news articles, a website summarizing an event, and other such external sources. By using one or more natural language techniques (e.g., text parsing, feature recognition, text classification, etc.), the external source collection module 222 identifies relevant nouns (e.g., proper names) (Operation 906). The external source collection module 222 then compares the relevant nouns with one or more names (e.g., a full legal name, a nickname, etc.) corresponding to various member profiles under consideration to be a featured member profile (Operation 908). The external source collection module 222 then identifies one or more member profiles based on the comparison (Operation 910). The external source collection module 222 then communicates with the members corresponding to the one or more identified member profiles (Operation 912). The communication may request confirmation that the member associated with the corresponding identified member profile is, in fact, named in the information obtained from the external source. In other words, the communication is an attempt to avoid attributing obtained information to the wrong person.

Where the member responds to the communication affirming that he or she is, in fact, mentioned in the information obtained by the external source collection module 222, the external source collection module 222 then associates the obtained information with the corresponding member profile (Operation 914). In one embodiment, the external source collection module 222 requests whether the member associated with the member profile would like to provide a brief summary of the external information, such that the brief summary is then listed on the member profile for viewing by other members. The featured profile selection module 214 then uses the listed event and/or achievement in its determination of the achievement value associated with the member profile (Operation 916).

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-9 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Architecture and Machine-Readable Medium

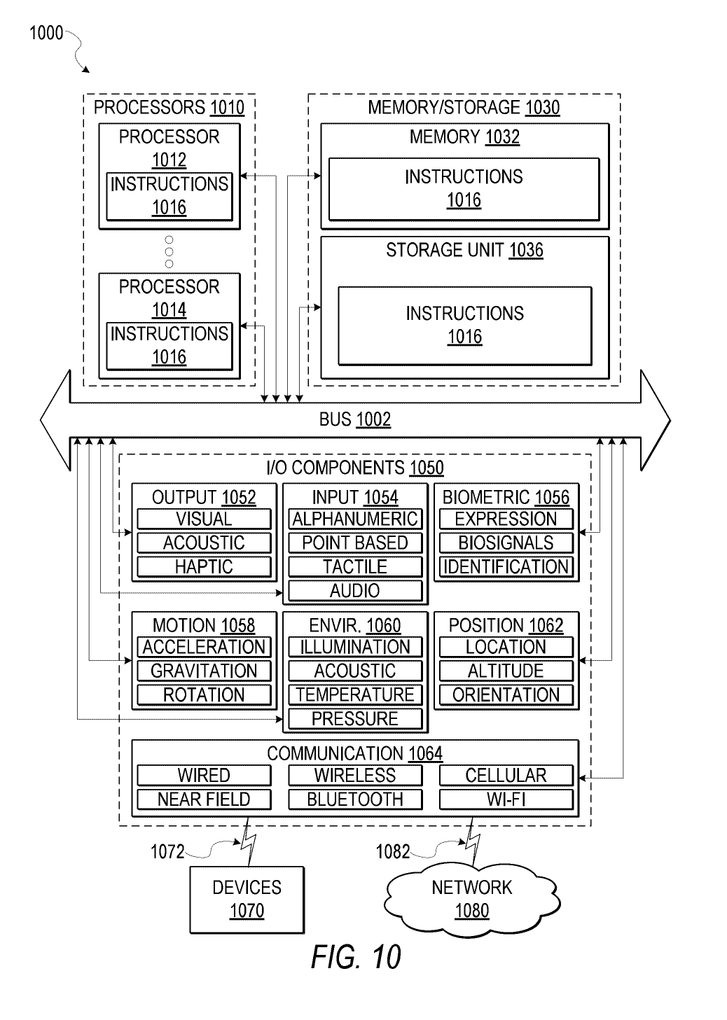

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions may cause the machine to execute the flow diagrams of FIGS. 6-9. Additionally, or alternatively, the instructions may implement the modules 208 of FIG. 2. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processor that may comprise two or more independent processors (sometimes referred to as “cores”) that may execute instructions contemporaneously. Although FIG. 10 shows multiple processors, the machine 1000 may include a single processor with a single core, a single processor with multiple cores (e.g., a multi-core process), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one processor in communication with the machine-readable medium that, having executed the computer-executable instructions, is configured to:
analyze a first plurality of user profiles maintained by a social networking service to determine whether a user associated with a user profile selected from the first plurality of user profiles has accomplished one or more predetermined events selected from a plurality of predetermined events;
assign an achievement value to each of the first plurality of user profiles, an achievement value corresponding to a user profile being determined based on the determination of whether the user associated with the user profile has accomplished the one or more predetermined events;
rank a second plurality of user profiles selected from the first plurality of user profiles, the ranking being performed according to the achievement value assigned to a corresponding user profile;
select at least one user profile from the second plurality of ranked user profiles to be a featured professional profile, the selection based on a threshold value defining a number of user profiles that are to be considered featured professional profiles;
access the social networking service to obtain profile information associated with the at least one featured professional profile; and
cause the display of the obtained profile information in a predetermined portion of a display in communication with a user device.

2. The system of claim 1, wherein the at least one processor is further configured to:
obtain a geographic location associated with each of the user profiles selected from the first plurality of user profiles;
determine a geographic region associated with the obtained geographic locations; and
select the second plurality of user profiles from the first plurality of profiles according to the determined geographic region; and
cause the display of the obtained profile information based on the determined geographic region.

3. The system of claim 2, wherein the at least one processor is further configured to:
obtain an industry associated with each of the user profiles selected from the second plurality of user profiles;
select a third plurality of user profiles from the second plurality of user profiles based on the industry associated with a corresponding user profile; and
rank the third plurality of user profiles selected from the second plurality of user profiles, the ranking being performed according to the achievement value assigned to a corresponding user profile.

4. The system of claim 1, wherein the at least one processor is further configured to:
cause the display of a third plurality of user profiles on the user device, the third plurality of user profiles being selected from the first plurality of user profiles based on the third plurality of user profiles being connected to a member profile that the third plurality of user profiles have in common; and
receive a nomination for at least one user profile selected from the third plurality of user profiles from a user represented by the common member profile, the nomination indicating a preference for the at least one user profile to be a featured professional profile.

5. The system of claim 4, wherein:
the second plurality of user profiles includes the third plurality of user profiles; and
the at least one processor is further configured to rank the second plurality of user profiles according to the received nomination.

6. The system of claim 1, wherein the at least one processor is further configured to:
send a message to a user associated with the selected at least one user profile to be featured as the featured professional profile, the message indicating the selection of the at least one user profile to be featured as the featured professional profile;
receive a reply from the user, the reply indicating a willingness by the user to have the at least one user profile be featured as the featured professional profile; and
assign a responsiveness value to the at least one user profile based on the timeliness of the received reply, the responsiveness value increasing the likelihood that the at least one user profile is selected as a featured professional profile.

7. The system of claim 1, wherein the at least one processor is further configured to:
communicate with a plurality of information sources external to the social networking service;
obtain first information from a first external source of information selected from the plurality of sources of information;
identify a predetermined set of features from the first information, at least one feature selected from the predetermined set of features corresponding to at least one user attribute used in defining a user profile maintained by the social networking service;
determine whether the first information qualifies as a predetermined event selected from the one or more predetermined events based on a comparison of at least one feature with at least one user attribute selected from at least one user profile selected from the first plurality of user profiles; and
adjust the achievement value associated with the at least one user profile based on the performed determination.

8. A method comprising:
analyzing, by at least one processor, a first plurality of user profiles maintained by a social networking service to determine whether a user associated with a user profile selected from the first plurality of user profiles has accomplished one or more predetermined events selected from a plurality of predetermined events;
assigning, by the at least one processor, an achievement value to each of the first plurality of user profiles, an achievement value corresponding to a user profile being determined based on the determination of whether the user associated with the user profile has accomplished the one or more predetermined events;
ranking, by the at least one processor, a second plurality of user profiles selected from the first plurality of user profiles, the ranking being performed according to the achievement value assigned to a corresponding user profile;
selecting, by the at least one processor, at least one user profile from the second plurality of ranked user profiles to be a featured professional profile, the selection based on a threshold value defining a number of user profiles that are to be considered featured professional profiles;
accessing, by the at least one processor, the social networking service to obtain profile information associated with the at least one featured professional profile; and
causing, by the at least one processor, the display of the obtained profile information in a predetermined portion of a display in communication with a user device.

9. The method of claim 8, further comprising:
obtaining a geographic location associated with each of the user profiles selected from the first plurality of user profiles;
determining a geographic region associated with the obtained geographic locations;
selecting the second plurality of user profiles from the first plurality of profiles according to the determined geographic region; and
causing the display of the obtained profile information based on the determined geographic region.

10. The method of claim 9, further comprising:
obtaining an industry associated with each of the user profiles selected from the second plurality of user profiles;
selecting a third plurality of user profiles from the second plurality of user profiles based on the industry associated with a corresponding user profile; and
ranking the third plurality of user profiles selected from the second plurality of user profiles, the ranking being performed according to the achievement value assigned to a corresponding user profile.

11. The method of claim 8, further comprising:
causing the display of a third plurality of user profiles on the user device, the third plurality of user profiles being selected from the first plurality of user profiles based on the third plurality of user profiles being connected to a member profile that the third plurality of user profiles have in common; and
receiving a nomination for at least one user profile selected from the third plurality of user profiles from a user represented by the common member profile, the nomination indicating a preference for the at least one user profile to be a featured professional profile.

12. The method of claim 11, wherein the second plurality of user profiles includes the third plurality of user profiles and the method further comprises ranking the second plurality of user profiles according to the received nomination.

13. The method of claim 8, further comprising:
sending a message to a user associated with the selected at least one user profile to be featured as the featured professional profile, the message indicating the selection of the at least one user profile to be featured as the featured professional profile;
receiving a reply from the user, the reply indicating a willingness by the user to have the at least one user profile be featured as the featured professional profile; and
assigning a responsiveness value to the at least one user profile based on the timeliness of the received reply, the responsiveness value increasing the likelihood that the at least one user profile is selected as a featured professional profile.

14. The method of claim 8, further comprising:
communicating with a plurality of information sources external to the social networking service;
obtaining first information from a first external source of information selected from the plurality of sources of information;
identifying a predetermined set of features from the first information, at least one feature selected from the predetermined set of features corresponding to at least one user attribute used in defining a user profile maintained by the social networking service;
determining whether the first information qualifies as a predetermined event selected from the one or more predetermined events based on a comparison of at least one feature with at least one user attribute selected from at least one user profile selected from the first plurality of user profiles; and
adjusting the achievement value associated with the at least one user profile based on the performed determination.

15. A machine-readable medium storing computer-executable instructions that, when executed by one or more processors, cause the one or more processors to perform a method, the method comprising:
analyzing, by at least one processor, a first plurality of user profiles maintained by a social networking service to determine whether a user associated with a user profile selected from the first plurality of user profiles has accomplished one or more predetermined events selected from a plurality of predetermined events;
assigning, by the at least one processor, an achievement value to each of the first plurality of user profiles, an achievement value corresponding to a user profile being determined based on the determination of whether the user associated with the user profile has accomplished the one or more predetermined events;
ranking, by the at least one processor, a second plurality of user profiles selected from the first plurality of user profiles, the ranking being performed according to the achievement value assigned to a corresponding user profile;
selecting, by the at least one processor, at least one user profile from the second plurality of ranked user profiles to be a featured professional profile, the selection based on a threshold value defining a number of user profiles that are to be considered featured professional profiles;
accessing, by the at least one processor, the social networking service to obtain profile information associated with the at least one featured professional profile; and
causing, by the at least one processor, the display of the obtained profile information in a predetermined portion of a display in communication with a user device.

16. The machine-readable medium of claim 15, wherein the method further comprises:
obtaining a geographic location associated with each of the user profiles selected from the first plurality of user profiles;
determining a geographic region associated with the obtained geographic locations;
selecting the second plurality of user profiles from the first plurality of profiles according to the determined geographic region; and
causing the display of the obtained profile information based on the determined geographic region.

17. The machine-readable medium of claim 16, wherein the method further comprises:
obtaining an industry associated with each of the user profiles selected from the second plurality of user profiles;
selecting a third plurality of user profiles from the second plurality of user profiles based on the industry associated with a corresponding user profile; and
ranking the third plurality of user profiles selected from the second plurality of user profiles, the ranking being performed according to the achievement value assigned to a corresponding user profile.

18. The machine-readable medium of claim 15, wherein the method further comprises:
causing the display of a third plurality of user profiles on the user device, the third plurality of user profiles being selected from the first plurality of user profiles based on the third plurality of user profiles being connected to a member profile that the third plurality of user profiles have in common; and
receiving a nomination for at least one user profile selected from the third plurality of user profiles from a user represented by the common member profile, the nomination indicating a preference for the at least one user profile to be a featured professional profile.

19. The machine-readable medium of claim 18, wherein the second plurality of user profiles includes the third plurality of user profiles and the method further comprises ranking the second plurality of user profiles according to the received nomination.

20. The machine-readable medium of claim 16, wherein the method further comprises:
sending a message to a user associated with the selected at least one user profile to be featured as the featured professional profile, the message indicating the selection of the at least one user profile to be featured as the featured professional profile;
receiving a reply from the user, the reply indicating a willingness by the user to have the at least one user profile be featured as the featured professional profile; and
assigning a responsiveness value to the at least one user profile based on the timeliness of the received reply, the responsiveness value increasing the likelihood that the at least one user profile is selected as a featured professional profile.
